(19) United States
(12) Patent Application Publication
(10) Pub. No.: US 2020/0349841 A1
(43) Pub. Date: Nov. 5, 2020

(54) LOCALIZED SPACE-TIME DEDICATED SHORT-RANGE COMMUNICATIONS MAP DATABASE GENERATION

(71) Applicant: VISTEON GLOBAL TECHNOLOGIES, INC, Van Buren Township, MI (US)

(72) Inventor: Richard D ZEROD, Chelsea, MI (US)

(73) Assignee: VISTEON GLOBAL TECHNOLOGIES, INC

(21) Appl. No.: 16/398,403

(22) Filed: Apr. 30, 2019

(51) Int. Cl. G08G 1/16; G01S 5/00; G06F 16/29; B60W 50/14

(52) U.S. Cl. CPC G08G 1/163; G08G 1/166; G01S 5/0072; B60W 2050/146; B60W 50/14; B60W 2050/143; G06F 16/29

(57) ABSTRACT

Various vehicle systems may benefit from suitable maintenance of geographic relations. For example, certain vehicle systems may benefit from localized space-time dedicated short-range communications map database generation. A system may include a receiver configured to receive a plurality of position and heading information messages at a vehicle. The system may also include a processor configured to determining an intersection overpass based on the plurality of position and heading information messages. The system may further include a configured configure to control the vehicle, or a transmitter configured to communicate with the vehicle, based on the determined intersection overpass.

### FIELD

Various vehicle systems may benefit from suitable maintenance of geographic relations. For example, certain vehicle systems may benefit from localized space-time dedicated short-range communications map database generation.

### RELATED ART

If there were no other vehicles on the road, a vehicle navigation system could rely on its own accurate and precise vehicle location information within the road to guide the vehicle along roads to a destination. The presence of other vehicles, however, complicates this navigation process, as the vehicle needs to avoid collisions with other vehicles.

In view of this need to avoid collisions with other vehicles, systems take into account the velocities of other vehicles. This information can optionally be gathered using primary sensors, such as active radar, light direction and ranging (LiDAR), or camera systems. The information can also be gathered using secondary systems, such as position reports from other vehicles.

When a vehicle approaches an overpass intersection, the vehicle may have insufficient information and not be able easily to determine that the intersection is an overpass intersection. Moreover, the algorithms and satellite systems for GPS and GNSS are not designed to provide a high accuracy in the vertical or elevation direction. For example, the vertical height clearance of overpasses can be as low as 4.3 meters, which can be less than the uncertainty limits of an elevation reported by the GNSS receiver. Accordingly, a system may mistakenly identify vehicles on an overpass as about to broadside a vehicle, even though the vehicles may safely pass above or beneath the vehicle. These false positives can be distracting to drivers and can lead the drivers to disable or ignore the collision warnings.

### SUMMARY

A system, according to certain embodiments, may include a receiver configured to receive a plurality of position and heading information messages at a vehicle. The system may also include a processor configured to determining an intersection overpass based on the plurality of position and heading information messages. The system may further include a processor configured to control the vehicle, or a transmitter configured to communicate with the vehicle, based on the determined intersection overpass.

A method, in certain embodiments, may include receiving a plurality of position and heading information messages at a vehicle. The method may also include determining an intersection overpass based on the plurality of position and heading information messages. The method may further include controlling or communicating with the vehicle based on the determined intersection overpass.

A non-transitory computer-readable medium may, in certain embodiments, be encoded with instructions that, when executed in hardware, perform a process. The process may include receiving a plurality of position and heading information messages at a vehicle. The process may also include determining an intersection overpass based on the plurality of position and heading information messages. The method process may further include controlling or communicating with the vehicle based on the determined intersection overpass.

### BRIEF DESCRIPTION OF THE DRAWINGS

The accompanying drawings are provided for purposes of illustration and not by way of limitation.

FIG. 1 illustrates a system according to certain embodiments.

FIG. 2 illustrates a method according to certain embodiments.

FIGS. 3A-3G illustrate a space-time vector example analysis, according to certain embodiments.

### DETAILED DESCRIPTION

Certain embodiments relate to a vehicle-implemented system and method for localized space-time dedicated short-range communications (DSRC) map database generation. DSRC may refer to a short-range wireless communication system intended for active safety applications. DSRC can be implemented using the IEEE 802.11p standard, or alternatively using cellular C-V2x technology. Active safety applications may include applications such as crash avoidance and warning systems. Each DSRC-equipped vehicle may periodically transmit the vehicle's own position. The position information may be provided as current latitude and longitude location. The position may be embedded in a Basic Safety Message (BSM). This position information may be determined using an on-board GPS or GNSS receiver.

Each DSRC vehicle may receive the BSM position information from nearby surrounding vehicles, along with additional information such as speed, heading, and several vehicle status flags. The BSM message format is standardized in SAE J2735. Nevertheless, certain embodiments apply to other communication standards, and certain embodiments apply to non-standardized communications.

A vehicle system can use the BSM information received from surrounding vehicles, along with the vehicle's own information on current position, heading, and speed, to determine the likelihood of a crash situation. The vehicle can then use the likelihood information to generate an alert, take a navigational action, or take some further safety action.

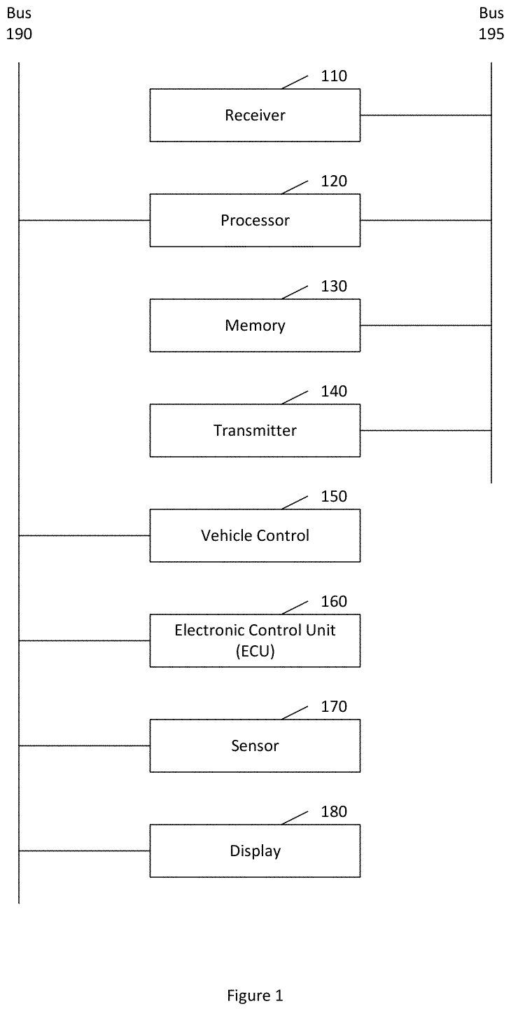

FIG. 1 illustrates a system according to certain embodiments. As shown in FIG. 1, a system can include a receiver 110. The receiver 110 can be any hardware for receiving communications, such as a transponder configured to receive DSRC communications, or other wireless communication signals. Other communication protocols are also permitted.

The system can also include a processor 120. This processor 120 can be any hardware-implemented computational device, such as an application specific integrated circuit (ASIC), central processing unit (CPU), or controller. The processor 120 can include one core or multiple cores. The processor 120 can be implemented as a single chip or multiple chips. The processor 120 can be implemented with on-board memory.

The system can include memory 130. This can be on a same chip as the processor 120 or can be on a different chip. Other implementations are also possible. The memory 130 can be random access memory (RAM). The memory 130 can also include additional storage, such as Flash memory, hard disk drives (HDDs) or optical storage. The memory 130 can be a computer-readable non-transitory storage medium, which can be encoded with instructions for performing a process, such as any of the processes described herein.

The system can also include a transmitter 140. This can be integral with or separate from receiver 110. For example, both transmitter 140 and receiver 110 can be implemented as a single transponder unit. The transmitter 140 can be configured to send DSRC messages. The transmitter 140 and receiver 140 can each be configured to communicate using various wireless protocols and radio access technologies. The processor, memory, receiver, and transmitter may transfer information to each other using a separate communication bus structure from the vehicle communication bus.

The system can also include a vehicle control unit 150. The vehicle control unit 150 may be variously embodied with processors, memories, controllers, and the like. The vehicle control unit 150 may interface with the vehicle's steering, throttle, braking, and the like. The vehicle control unit 150 may permit assisted or autonomous driving of the vehicle. The vehicle control unit 150 may provide feedback, including for example haptic feedback, to a user of the vehicle, such as a human driver of the vehicle.

The system can additionally include electronic control units (ECUs), such as ECU 160. ECU 160 may be any electronic control unit of a vehicle including, for example, driver assistance controller or driver assistance module.

The system can further include one sensor 170 or many sensors. The sensor 170 may be a device used to determine own location (for example, a global positioning system (GPS) unit), own heading (for example, a compass), own movement (for example, an odometry unit), or environment. Environmental measurements obtained by the sensor 170 may include the use of one or more visible light and/or infrared camera, light detection and ranging (LiDAR), radar devices, sonic and/or ultrasonic sensors broadly including microphones.

The system can also include one display 180 or many displays. The display 180 can be part of a vehicle's instrument panel, infotainment center, head-up display (HUD), or any other desired display. The system can also be connected to other vehicle systems, such as the horn, the lights, and so on.

The various components of the system may be connected by a bus 190. This may be a car area network (CAN) bus or any other communication bus or other communication network. It is not necessary that a bus interconnection be used. For example, various other components can be integrated together. Other connection topologies, such as a star topology with the processor 120 as the center of the star, are also possible. Also, a second bus 195 or other interconnection can connect the processor 120 to the receiver 110, memory 130, and transmitter 140. Other arrangements are also permitted.

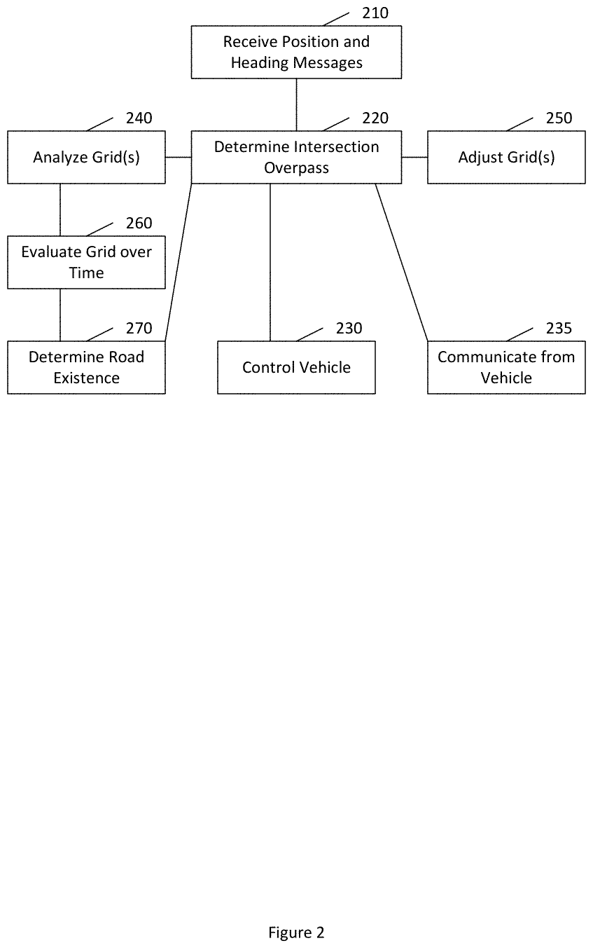

FIG. 2 illustrates a method according to certain embodiments. As shown in FIG. 2, a method can include, at 210, receiving a plurality of position and heading information messages at a vehicle. This can be performed using, for example, the receiver 110 in FIG. 1. The position and heading information messages can be provided within basic safety messages. The basic safety messages can be selected from a dedicated short-range communication message set dictionary. SAEJ2735 is one example of such a message set dictionary.

The position and heading information messages can be from vehicles near the vehicle. Thus, these messages may be received directly from those other vehicles. Alternatively, the messages may be relayed by other vehicles or by infrastructure repeaters.

The position and heading messages can be received while the vehicle is traversing a route. The intersection overpass can overlap the route. Thus, for example, the vehicle itself may go under or over the intersection overpass. In certain embodiments, the vehicle itself may merely go near the intersection overpass, but may nevertheless receive messages relevant to the intersection overpass. Near, in this example, may be defined as being within direct reception range of wireless communication signals from vehicles in the intersection overpass.

The method can also include, at 220, determining an intersection overpass based on the plurality of position and heading information messages. The vehicle may not be equipped with a map database that identifies the intersection overpass prior to the determining. Thus, in certain embodiments an unequipped vehicle can nevertheless determine the intersection overpass location.

The determining can be done in a variety of ways, which can be used alone or in combination with other ways. For example, the determining can be based on travel patterns of surrounding vehicles derived from the position and heading information messages.

The determining can include, at 240, analyzing the plurality of position and heading information messages with respect to a plurality of grid sections. The grid sections are used to construct a map consisting of discrete geographic areas bounded by latitude and longitude coordinates. The latitude and longitude coordinates used to define each grid section can be assigned statically or dynamically. For an example of dynamic assignment, the number and size of each grid sections can be adjusted based on how often the vehicle travels along specific routes. When initially travelling into a new geographic area the grid size can be larger, as the specific location of roads may be currently unknown. Considering the vehicle-to-vehicle DSRC communication ranges is typically limited to about 1 Km, this sets an initial upper limit of about 1 sq. Km for each grid square. As the number of surrounding vehicles report positions inside each grid square begins to grow, the grid square can then be subdivided into smaller grid squares to obtain increased map resolution. Conversely, grid squares that do not contain any surrounding vehicles can eventually be discarded as the likelihood of any roads occupying those areas is diminishingly small.

The method can also include, at 250, adjusting the geographic size of the grid based on the number of vehicles contained in the grid section. Thus, for example, if a grid has above a predetermined threshold number of vehicles, such as 20 vehicles, the size of the grid can be reduced until the predetermined threshold is not exceeded or a minimum grid size is reached.

The analyzing at 240 can include assigning each position and heading information of the plurality of position and heading information messages to a grid section of the plurality of grid sections. Each position and heading information can be stored in memory to allow for an analysis over the total number of vehicles travelling inside each grid section. The uncertainty in the analysis can be reduced with a larger sample intervals which can result in a larger total number of sample points inside each grid section.

The method can also include, at 260, evaluating each grid section over time to determine at least one of a number of vehicles contained in the grid section or a direction of travel of each vehicle in the grid section. The sampling interval required to obtain a sufficient amount position and heading sample points information may be dependent on the dynamic grid size and the traffic flow and traffic density of any roads contained within the grid section. Furthermore, the traffic flow and traffic density may be dependent on additional variables, such as the time of day, weather conditions, and type of roads. Thus, the sampling period can be dynamic. For example, the sampling interval may be long enough to obtain several thousand position and heading sample points per square kilometer. The method can further include, at 270, determining that one or more roads exist with coordinates corresponding to the vehicles based on the evaluating. The determining that the one or more roads exist can be based on vehicle density per grid over a sampling interval. Additional road characteristics can be estimated, such as the direction of the roads, the number of individual lanes within a road, or whether a road is a one-way or two-way road.

The determining of the intersection overpass at 220 can, in certain embodiments, include determining at least one intersection of the plurality of roads based on the evaluating at 260 and road existence determination at 270. The determining at 220 can further include determining the at least one intersection based on heading information from the position information messages. Furthermore, the determining at 220 can include determining that an intersection overpass exists based on a plurality of vehicles simultaneously within a grid section with substantially the same position information but with different heading information.

The method can further include, at 230, controlling a vehicle based on the determined intersection overpass or, at 235, communicating with the vehicle based on the determined intersection overpass. The communicating can include issuing a visual or audible warning to a driver of the vehicle or an alert to a driver assistance controller or driver assistance module of the vehicle.

Thus, certain embodiments can use space-time vector analysis of DSRC basic safety messages (BSMs) received from surrounding vehicles to generate the location of intersection overpasses along frequently traveled routes when a sufficient sample size becomes available. This information can be used to minimize the number of false-positive crash avoidance safety alerts presented to the driver due to the relatively poor elevation position accuracy performance of typical GPS or Global Navigation Satellite System (GNSS) receivers.

Certain embodiments can dynamically learn overpass locations from travel patterns of surrounding vehicles. This approach may be a low-cost alternative to embedding a pre-populated navigation style map database in a DSRC on board unit.

Certain embodiments can divide a localized area, such as frequently traveled routes, for example home to work, or the like. This localized area can be divided into discrete latitude and longitude grid sections in an X-Y plane. Each grid section can be assigned a location reference designation value, such as A1, C12, E17, or the like. The value can correlate to a geographic boundary that is defined by a set of latitude and longitude values. The size scaling of the X-Y plane, and the number of individual grid sections, can be dynamic and can be adjusted as new routes are driven.

Within the driver's vehicle, the location and direction of travel information can be extracted from the BSM messages of the surrounding vehicles within the reception range. This information from each vehicle can then be assigned to a specific grid section. BSM messages may, in certain instances, be transmitted at approximately a 10 Hz rate. The sampling process can continue until a sufficient number of sample values become available. The sufficient number of samples may depend on the length of the travel route.

Once a sufficient number of samples is available, each individual grid section can be analyzed over time to determine the number of individual vehicles the grid contains, and the direction of travel of each vehicle within the grid section. By calculating the vehicle density per grid over a sampling interval it may be possible to estimate the location of individual roads and where they intersect. By calculating the travel direction per grid it may also be possible to estimate the road orientations, for example North-South or East-West roads, and so on. By calculating a number of simultaneous vehicles per grid, where the relative vehicle orientations are not approximately 0 degrees or 180 degrees, it may be possible to estimate the location of overpasses.

The BSM message may also contain (in addition to vehicle latitude and longitude) vehicle elevation information. This vehicle elevation information may have a significant amount of uncertainty. For example, some systems have an accuracy of +/−3.5 meters with 50% probability, which means that sometimes vehicles on an overpass may appear below (or at the same level as) vehicles that are actually on a lower road surface. This additional information can be used to supplement the results of estimation based on orientation and density.

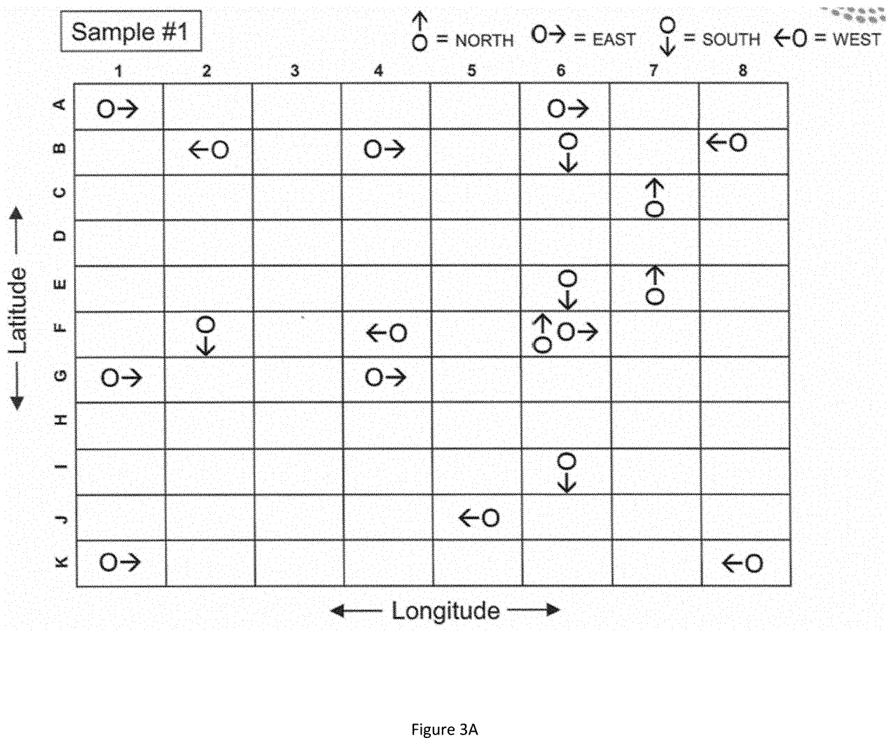

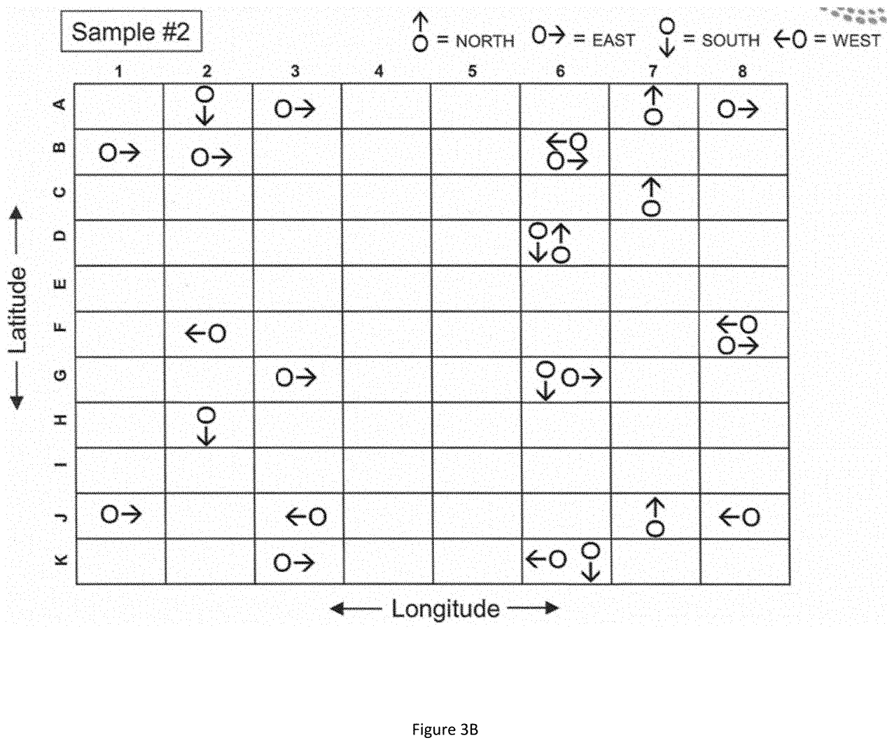

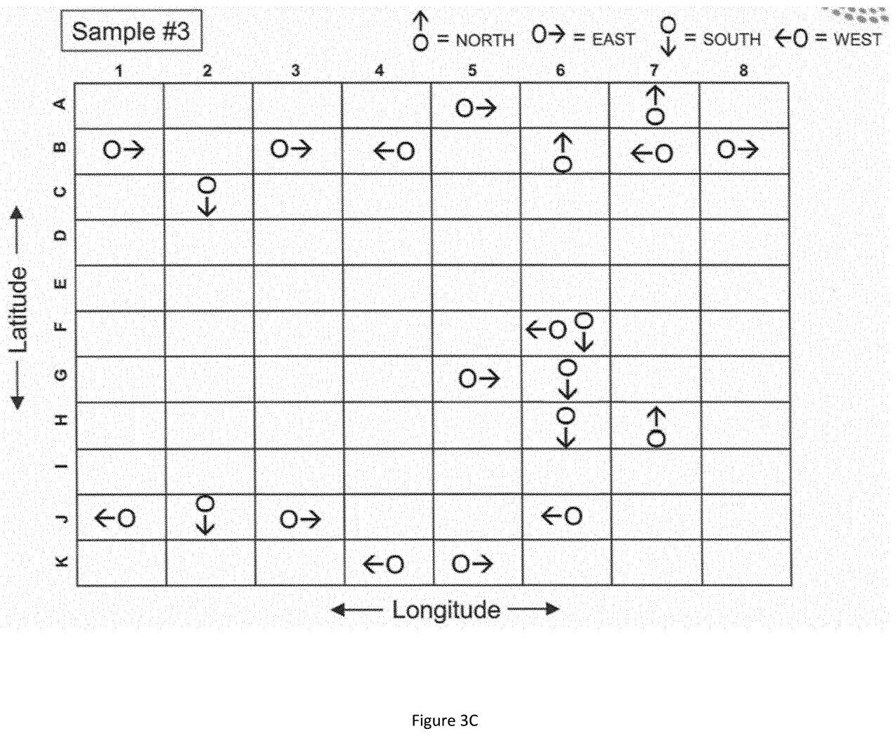

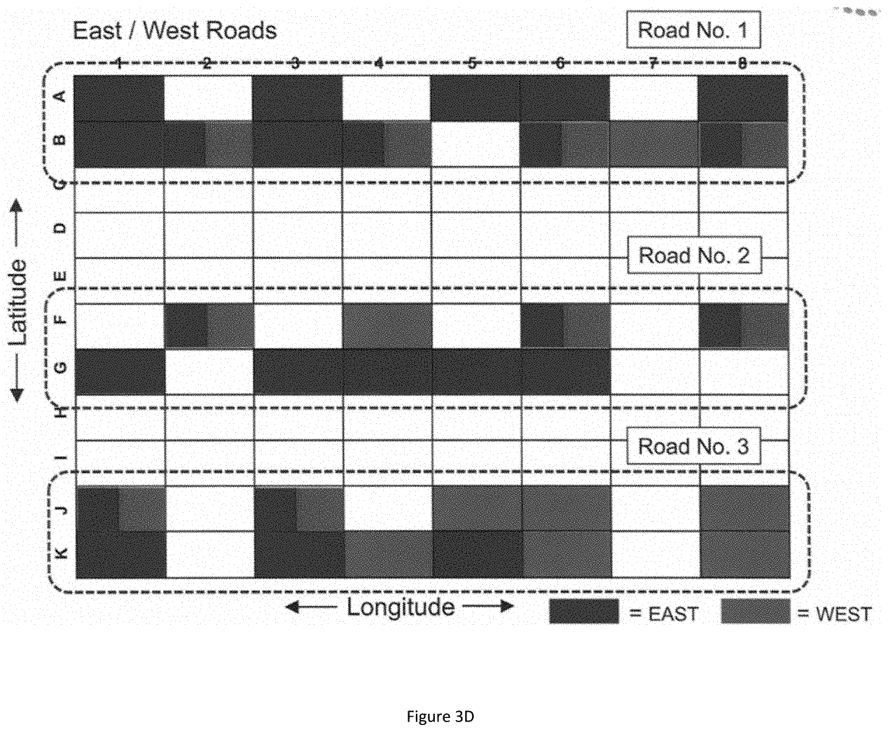

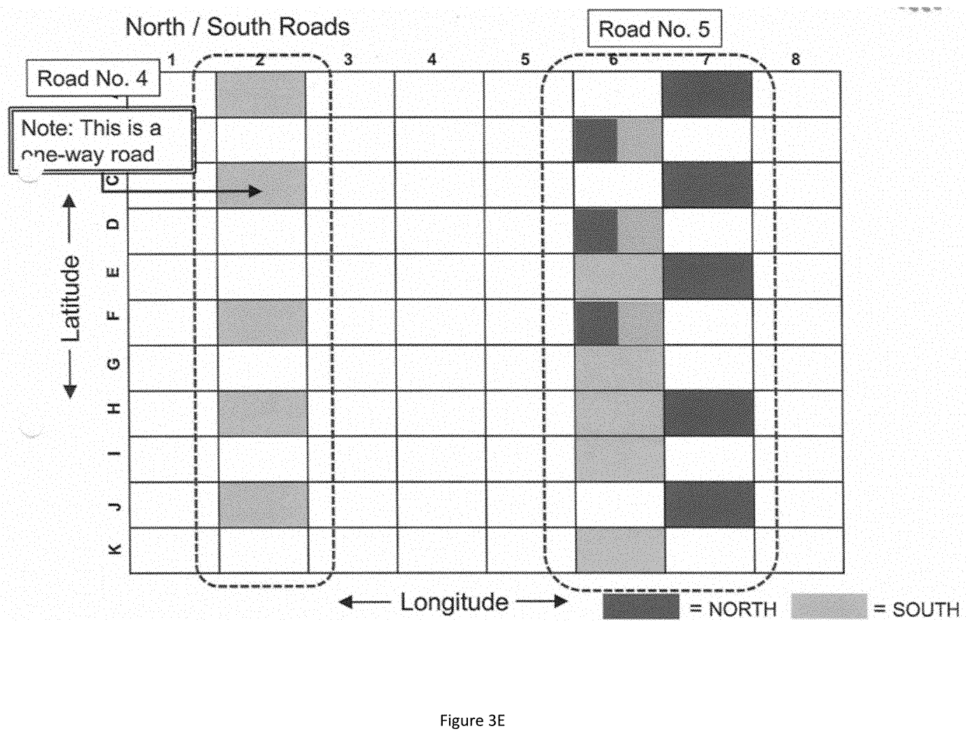

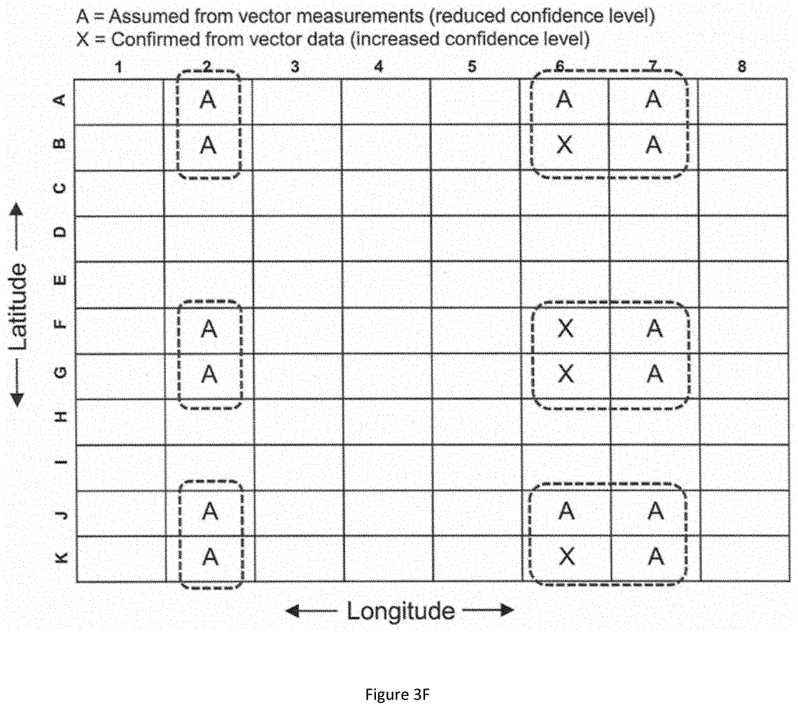

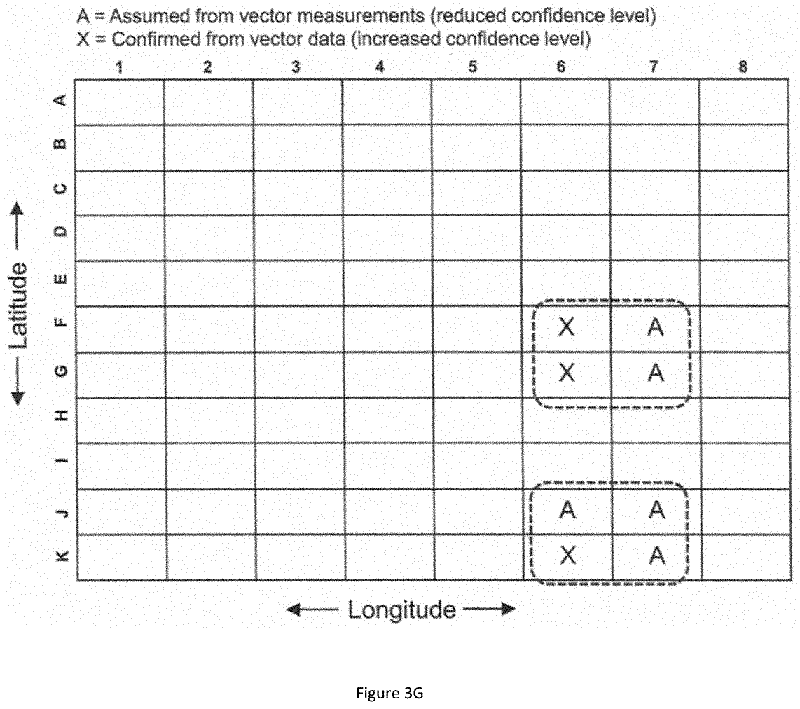

FIGS. 3A-3G illustrate a space-time vector example analysis, according to certain embodiments. In this example, the grid areas are static to make the illustration simpler. As shown in FIG. 3A, during a certain sample period (perhaps a tenth of a second), reports can be received from other vehicles at various latitudes and longitudes and reporting various headings. In this case, all the vehicles are traveling due north, south, east, or west, once again simply for ease of illustration. As can be seen in FIG. 3A, there can be a vehicle heading east, in cell A1 of the grid, while other vehicles are present in other cells of the grid. In cell F6, there is a vehicle traveling east and another vehicle traveling north. Alternatively, Sample 1 in FIG. 3A may illustrate a first collection of samples received while a vehicle was traveling a route within the grid.

The data even from the single sample in FIG. 3A may already raise a question regarding whether some intersections may exist, such as at F6. Based only on this sample, it may be hard to tell whether F6 is a simple intersection or an overpass intersection, or even whether the vehicles are actually on different roads within the same grid cell.

FIG. 3B illustrates a second sample, taken at a different time. This second sample may be taken at a similar time of day the following day from the first sample. Alternatively, the second sample may simply be a second sample taken shortly after the first sample. The second sample raises similar questions as the first sample. Furthermore, the presence of opposite-heading vehicles in the same grid cell at B6 suggests that the grid size may be big enough to accommodate a two-way street. The same inference may be drawn about cells F8 and D6, for the same reason. The presence of orthogonal vehicles in cells G6 and K6 suggest possible intersections.

FIG. 3C illustrates a third sample, taken at a third time. This sample similarly may raise the same kinds of questions. Cell F6 looks like a possible intersection, for example. Similarly, row B and column 6 are possible two-way streets, as vehicles in the same row or column are headed in different directions.

FIG. 3D illustrates east/west road determinations based on the three samples in FIGS. 3A through 3C. Considering the data for vehicles heading east or west, the system may infer the presence of three roads from the samples, with each of these roads appearing to be two-way roads.

FIG. 3E illustrates north/south road determinations based on the three samples in FIGS. 3A through 3C. Considering the data for vehicles heading north or south, the system may infer the presence of two roads from the samples, with one of these roads appearing to be a one-way road, and the other road appearing to be a two-way road.

FIG. 3F illustrates a first intersection analysis. As shown in FIG. 3F, possible intersections can be identified based on assumptions about road continuity and from projections of the vehicles speed and heading. As can be seen an intersection has been determined to exist at cell B6 based on vehicles travelling in the south, west, east, and north directions in this cell during the earlier sample intervals shown in FIGS. 3A, 3B, and 3C, respectively. However the intersection which contains cell B6 is likely to occupy additional adjacent cells since an east/west road occupies row A and row B in FIG. 3D, and a north/south road occupies column 6 and column 7 in FIG. 3E. The intersection is assumed to occupy the union of cells at the intersection of these two roads including cells A6, B6, A7, and B7, although the limited sample data for cells A6, A7, and B7 only shows vehicles travelling in a single direction. A similar situation exists in cells F6, G6, and K6 where vehicles are travelling at orthogonal directions in these cells during the sample intervals shown in FIGS. 3A, 3B, and 3C but the intersection is assumed to occupy the union of points of the intersecting east/west and north/south roads in FIGS. 3D and 3E. Intersections are also assumed at cells A2 and B2, cells F2 and G2, and cells J2 and K2 as they represent the union of points of the intersecting east/west and north/south roads in FIGS. 3D and 3E. These possible intersections can then be confirmed by reliance on vector data from vehicles apparently in the actual intersections.

FIG. 3G illustrates a second intersection analysis used to identify the location of overpasses. Once again, the possible intersections are identified by assumptions from vectors outside the intersection and confirmed with vector data from vehicles in the intersection. As can be seen an overpass has been determined to exist at cell F6 based on vehicles simultaneously travelling in the north and east directions in this cell as shown in FIG. 3A. Similarly, an overpass has been determined to exist at cell G6 based on vehicles simultaneously travelling in the south and east directions in this cell as shown in FIG. 3B. An overpass has also been determined to exist at cell K6 based on vehicles simultaneously travelling in the west and south directions in this cell as shown in FIG. 3B. However the overpasses which contains cells F6, G6, and K6 are likely to occupy additional adjacent cells since east/west roads occupies rows F, G, J and K in FIG. 3D, and a north/south road occupies column 6 and column 7 in FIG. 3E. Two overpasses are assumed to occupy the union of cells at the intersection of these roads consisting of cells F6, G6, F7, and cells J6, K6, J7 and K7. Based on the analysis results at FIGS. 3F and 3G, the system may determine that intersection overpasses exist at the two boxed areas in FIG. 3G.

Certain embodiments may have various benefit and/or advantages. For example, because the position and heading information can be provided over a wireless medium, the approach of certain embodiments may not be dependent on a line-of-sight condition between the vehicles. Thus, certain embodiments may be able to obtain information about nearby vehicles that are visually blocked by nearby buildings or structures, such as vehicles around a corner but not visible. Other sensors, such as radar, camera, and LiDAR sensors do not have this ability.

In certain embodiments, the position and heading information obtained can be provided as an additional sensor input for advanced driver assistance system (ADAS) applications.

Additionally, in certain embodiments, the additional map information provided through the systems and techniques described above, may be used to limit or avoid false positives of collision detection. Thus, for example, a vehicle on a lower road may be able to take into account that a vehicle on an intersecting path is traveling on a road that includes an overpass. Thus, the vehicle on the lower road can avoid taking evasive action based on a vehicle on an overpass. Likewise, a vehicle traveling (or about to travel) on an overpass can avoid treating vehicles on a lower road as a threat to be avoided. In this way, for example, collisions can be avoided without unnecessary warnings to a driver and/or without unnecessary maneuvers by an autonomous vehicle. This may be particularly helpful in topologies where both intersecting roadways are on the same plane at some distance from the overpass, and subsequently one of the two roadways becomes elevated to pass over the other, or one of the two roadways tunnels under the other. In such cases, even an accurate initial altitude measurement of two vehicles might predict a collision. This erroneous prediction, however, can be avoided once the presence of an overpass is noted at the place where the otherwise predicted collision would occur.

What is claimed is:

1. A system, comprising:
a receiver configured to receive a plurality of position and heading information messages at a vehicle;
a processor configured to determine an intersection overpass based on the plurality of position and heading information messages; and
a controller configured to control the vehicle, or a communicator configured to communicate using the vehicle, based on the determined intersection overpass.

2. The system of claim 1, wherein the position and heading information messages are contained within basic safety messages.

3. The system of claim 2, wherein the basic safety messages are selected from a dedicated short-range communication message set dictionary.

4. The system of claim 1, wherein the position and heading information messages are from vehicles near the vehicle.

5. The system of claim 1, wherein the position and heading messages are received while the vehicle is traversing a route, and wherein the determined intersection overpass overlaps the route.

6. The system of claim 1, wherein the vehicle is not equipped with a map database that identifies the intersection overpass prior to the determining.

7. The system of claim 1, wherein the processor is configured to make the determination based on travel patterns of surrounding vehicles derived from the position and heading information messages.

8. The system of claim 1, wherein the processor is configured to make the determination by analyzing the plurality of position and heading information messages with respect to a plurality of grid sections.

9. The system of claim 8, wherein a total number of grid sections, or a geographic size of each grid section, or both are dynamic.

10. The system of claim 8, wherein the total number of grid sections is adjusted based on routes traveled by the vehicle.

11. The system of claim 9, wherein the processor is further configured to adjust the geographic size based on a total number of vehicles contained in the grid section.

12. The system of claim 8, wherein the processor is configured to assign each position and heading information of the plurality of position and heading information messages to a grid section of the plurality of grid sections.

13. The system of claim 12, wherein the processor is configured to evaluate each grid section over time to determine at least one of a number of vehicles contained in the grid section or a direction of travel of each vehicle in the grid section.

14. The system of claim 13, wherein the processor is configured to determine that one or more roads exist with coordinates corresponding to the vehicles based on the evaluating.

15. The system of claim 14, wherein the processor is configured to determine that the one or more roads exist is based on vehicle density per grid over a sampling interval.

16. The system of claim 13, wherein the processor is configured to determine at least one intersection of a plurality of roads based on the evaluating.

17. The system of claim 16, wherein the processor is further configured to determine the at least one intersection based on heading information from the position information messages.

18. The system of claim 13, wherein the processor is configured to determine that an intersection overpass exists based on a plurality of vehicles simultaneously within a grid section with substantially the same position information but with different heading information.

19. The system of claim 1, wherein the communicator is configured to issue a visual or audible warning to a driver of the vehicle or an alert to a driver assistance controller or driver assistance module of the vehicle.

20. A non-transitory computer-readable medium encoded with instructions that, when executed in hardware, perform a process, the process comprising:
receiving a plurality of position and heading information messages at a vehicle;
determining an intersection overpass based on the plurality of position and heading information messages; and
controlling or communicating with the vehicle based on the determined intersection overpass.
